(19) United States
(12) Patent Application Publication
(10) Pub. No.: US 2020/0279418 A1
(43) Pub. Date: Sep. 3, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masato ANDO, Kanagawa (JP); Hirokazu MUKAI, Kanagawa (JP)

(73) Assignee: FUJI XEROX CO., LTD., Tokyo (JP)

(21) Appl. No.: 16/524,569

(22) Filed: Jul. 29, 2019

(30) Foreign Application Priority Data
Feb. 28, 2019 (JP) 2019-036717

(51) Int. Cl. G06T 11/20; G06T 11/00

(52) U.S. Cl. CPC G06T 11/206; G06T 2200/24; G06T 11/001

(57) ABSTRACT

An information processing apparatus includes a setting unit and a display unit. The setting unit sets additional information to each of components constituting a relation diagram on the relation diagram expressing a structure between events. The display unit distinguishably displays each of the components having the additional information set thereto in accordance with the additional information.

### CROSS-REFERENCE TO RELATED APPLICATIONS

This application is based on and claims priority under 35 USC 119 from Japanese Patent Application No. 2019-036717 filed Feb. 28, 2019.

### BACKGROUND

### (i) Technical Field

The present disclosure relates to information processing apparatuses and non-transitory computer readable media.

### (ii) Related Art

A system that utilizes multiple physical phenomena normally has a large number of events that are linked in a chained manner. For example, for a result, such as the final quality of a product, there are multiple events serving as factors of the result, there are more events serving as factors occurring as a result of those events, there are even more events serving as factors occurring as a result of those events, and so on.

Because such a complex system has many qualities that have to be satisfied, the cause-and-effect relationship between a design group and a quality group is extremely complex. Therefore, it is difficult to find a design item for satisfying a desired quality, and changing a design value for satisfying a certain quality may problematically have an adverse effect on another quality.

There are several known methods for visualizing and organizing such a complex cause-and-effect relationship between events. One representative method involves the use of a relation diagram and a quality function deployment table. A relation diagram expresses connections between events, and one typical example is a logic tree that expresses cause-and-effect relationships by connecting results of events with events serving as factors of the results by using relationship lines. A quality function deployment table is also called a QFD table in which axes having events arranged on half-lines are disposed orthogonally to each other. In the QFD table, the relationships between events on the axes are expressed using symbols or numerical values disposed in a matrix fashion between neighboring axes.

A relation diagram is suitable for indicating results and factors therefor in detail without missing or overlapping items. However, when there are too many events as targets, the diagram becomes too complex and large, thus making it difficult to practically use the diagram. On the other hand, a quality function deployment table expresses cause-and-effect relationships in a matrix by extracting events of importance from many events and arranging them on the axes. Thus, a quality function deployment table may be used for concisely expressing the relationships between many results and many factors. However, a quality function deployment table is not capable of expressing specific cause-and-effect relationships including events not disposed on the axes. As a result, missing items or incomplete items tend to occur. By using both a relation diagram and a multiaxial quality function deployment table, it is conceivable that the cause-and-effect relationships between events may be extracted and described in detail without missing or overlapping items, while the cause-and-effect relationships between many events of factors and many events of results may be expressed in a concise manner.

Japanese Unexamined Patent Application Publication No. 2014-112338 discloses an information processing apparatus that displays items that are linked with an item on a first axis within a quality function deployment table and that are disposed on a second axis adjacent to the first axis and on a third axis adjacent to the second axis. When the information processing apparatus disclosed in Japanese Unexamined Patent Application Publication No. 2014-112338 selects a first item from the first axis within the quality function deployment table, the information processing apparatus calculates a relationship with an item belonging to the second axis adjacent to the first axis so as to extract a second item from the second axis, also calculates a relationship with the first item from the relationship between the extracted second item and an item belonging to the third axis adjacent to the second axis so as to extract a third item, and displays these items. The relationships between the items in the hierarchical structure are analyzed in this manner, so that the cause-and-effect relationships are displayed in a spread manner not only in one direction but also in alternating directions.

### SUMMARY

Aspects of non-limiting embodiments of the present disclosure relate to an information processing apparatus and a non-transitory computer readable medium that display information added to components constituting a relation diagram in an identifiable manner when the relation diagram expressing a structure between events is to be created or corrected.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a setting unit and a display unit. The setting unit sets, on a relation diagram expressing a structure between events, additional information to each of components constituting the relation diagram. The display unit distinguishably displays each of the components having the additional information set thereto in accordance with the additional information.

### BRIEF DESCRIPTION OF THE DRAWINGS

Exemplary embodiments of the present disclosure will be described in detail based on the following figures, wherein:

FIG. 1 illustrates an example of a relation diagram;

FIG. 2 schematically illustrates the configuration of an information processing apparatus according to an exemplary embodiment of the present disclosure;

FIG. 3 illustrates how flags are set in a relation diagram according to an exemplary embodiment of the present disclosure;

FIG. 4 illustrates an example of an event-component attribute table;

FIG. 5 illustrates an example of a connection-component attribute table;

FIG. 6 illustrates an example of a flag setting table; and

FIG. 7 illustrates how components having flags set thereto are displayed by being surrounded by a frame.

### DETAILED DESCRIPTION

Relation Diagram

A relation diagram is expressed as a tree diagram in which connecting lines are used to describe the structures between multiple events so as to make the structures between the events visible. In particular, a tree diagram is constituted of graphic patterns describing events of factors and results and uses lines to connect dependence relationships between the events in accordance with the dependencies thereof. This tree diagram may sometimes be referred to as a logic tree. A relation diagram in which many events are linked in a chained and intersecting manner is often created by multiple persons, and the creator and the referrer are often different from each other. In such a case, it is difficult to find afterwards the noteworthy points of discussion and the updated sections in the relation diagram.

An exemplary embodiment of the present disclosure involves setting flags as additional information to be added by a user to graphic components constituting the relation diagram, and distinguishably displaying the components in accordance with the types of the flags, so that when the relation diagram is to be created or corrected, noteworthy points of discussion and updated sections may be readily identifiable. First, a simple description of the relation diagram will be provided here.

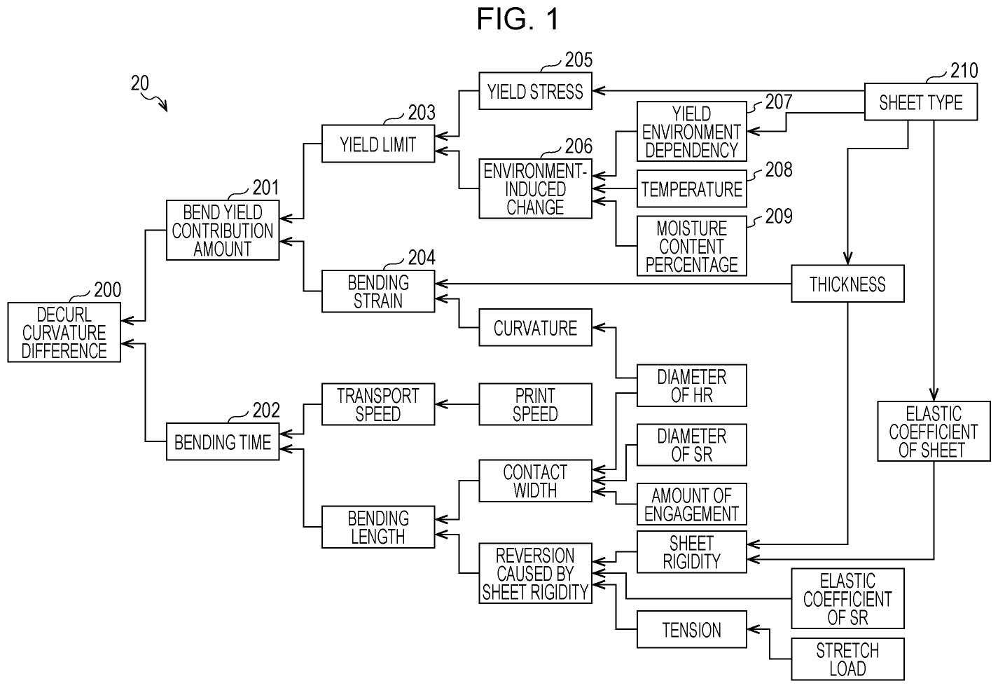

FIG. 1 illustrates an example of the relation diagram. In an exemplary embodiment of the present disclosure, the relation diagram has a hierarchical structure including, for example, a quality demanded in a product by a client, a function for achieving the quality, a physical property value for achieving the function, and a design parameter (control parameter) for achieving the physical property value.

A relation diagram 20 shown in FIG. 1 includes a decurl curvature difference 200 as a printing-sheet quality demanded by a client, a bend yield contribution amount 201 and a bending time 202 as functions for achieving the quality, and a yield limit 203 and a bending strain 204 as physical properties for achieving the bend yield contribution amount 201. Moreover, the relation diagram 20 further includes a yield stress 205, an environment-induced change 206, and a yield environment dependency 207 as physical properties for achieving the yield limit 203, a sheet type 210 as a design parameter for achieving the yield stress 205 and the yield environment dependency 207, and a temperature 208 and a moisture content percentage 209 as design parameters for achieving the environment-induced change 206.

In the relation diagram 20, the events are connected by lines each having an arrow at the distal end thereof. An event at the base end of each arrow indicates a factor, whereas an event at the distal end of each arrow indicates a result. Therefore, for example, the bend yield contribution amount 201 and the bending time 202 are related to the decurl curvature difference 200. Although the lines indicating the relationships between the events are all expressed with the same type of lines in the relation diagram 20, the lines may be displayed with different thicknesses and with different types in accordance with the relationships between the events.

If a product is to be manufactured, for example, when the sheet type 210 serving as the design parameter of the lowest level is changed, the yield stress 205 changes accordingly. When the yield stress 205 changes, the yield limit 203 changes. When the yield limit 203 changes, the bend yield contribution amount 201 changes, thus causing the decurl curvature difference 200 as the demanded quality to be affected accordingly. When a product is to be designed, the sheet type 210 and other design parameters are set such that the ultimately demanded quality is obtained. Thus, the relation diagram 20 should be created such that there are no missing items or overlapping items.

### Exemplary Embodiment of Present Disclosure

An exemplary embodiment of the present disclosure will be described in detail below with reference to the drawings.

Configuration of Information Processing Apparatus

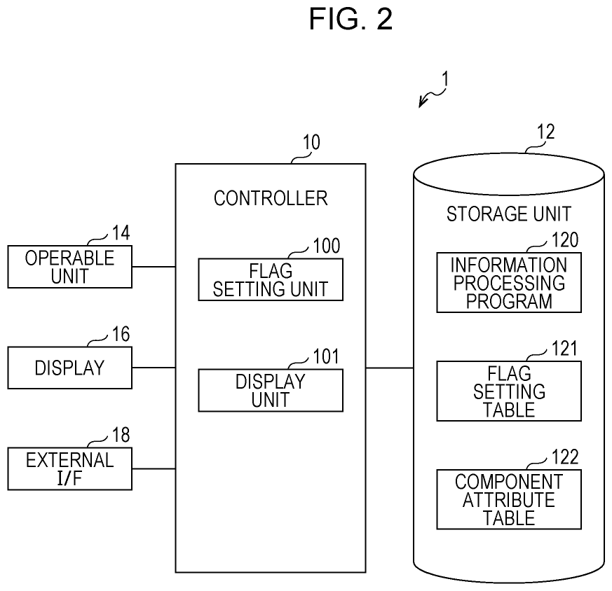

FIG. 2 schematically illustrates the configuration of an information processing apparatus according to an exemplary embodiment of the present disclosure. As shown in FIG. 2, an information processing apparatus 1 includes a controller 10, a storage unit 12, an operable unit 14, a display 16, and an external interface (I/F) 18.

The controller 10 is constituted of, for example, a central processing unit (CPU) and a memory. The controller 10 controls each unit and executes various types of programs. The controller 10 includes a flag setting unit 100 and a display unit 101.

The storage unit 12 is constituted of a storage device, such as a hard disk drive (HDD) or a flash memory, and stores information. The storage unit 12 includes an information processing program 120, a flag setting table 121, and a component attribute table 122.

The operable unit 14 used may be appropriately selected from a keyboard, mouse, or touchscreen. The display 16 displays, for example, text and images and is constituted of, for example, a display device, such as a liquid crystal display (LCD). The external I/F 18 connects the information processing apparatus 1 to an external database or another system apparatus via, for example, a line.

The controller 10 functions as, for example, the flag setting unit 100 and the display unit 101 by executing the information processing program 120 stored in the storage unit 12.

The flag setting unit 100 sets a flag to a component constituting the relation diagram 20 in accordance with a command from the creator. The display unit 101 causes the display 16 to display a flag setting status for a component in the relation diagram 20 in accordance with a command from the creator. Detailed operation will be described later.

The information processing program 120 stored in the storage unit 12 causes the controller 10 to function as the above-described units. When a flag is set to a component in the relation diagram 20, the flag setting table 121 displays a list of flag setting statuses indicating the setting statuses of flags set to which of the components under what conditions. The component attribute table 122 indicates attributes, such as the created (updated) date and the creator, of each component in the relation diagram 20.

### Operation According to Exemplary Embodiment of Present Disclosure

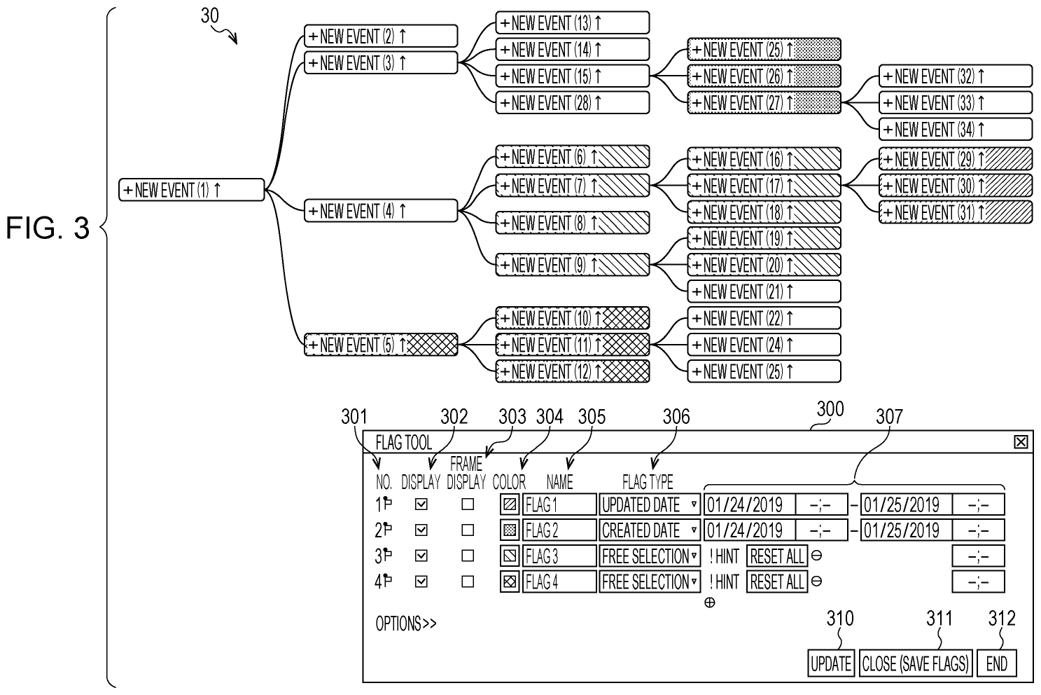

Next, the operation according to the exemplary embodiment of the present disclosure will be described with reference to FIG. 3. FIG. 3 illustrates how flags are set in a relation diagram according to an exemplary embodiment of the present disclosure.

As shown in FIG. 3, the relation diagram includes event components indicating events, such as a new event (1), displayed by being surrounded by rectangular frames, and also includes connection components indicating the relationships between the event components and displayed by using lines connecting the event components.

As mentioned above, the relation diagram has a plurality of hierarchy structures, including a quality, a function, a physical property value, and a design parameter, between the displayed event components. An arrow is displayed in a frame indicating each event component and indicates whether a value expressing the event described in the event component is to be increased or decreased. Specifically, an upward arrow indicates that the value is to be increased, whereas a downward arrow indicates that the value is to be decreased. In FIG. 3, an event component at the left side is a master event, and an event component at the right side is a slave event.

In the example shown in FIG. 3, since the arrows are all oriented upward, the value of each master event is increased when the value of any of the corresponding slave events is increased. Normally, there is a mixture of upward arrows and downward arrows, and there may be various relationships between slave events and master events.

In FIG. 3, the connection components indicating the relationships between the event components are all displayed using lines of the same type. Alternatively, the lines may be displayed with different thicknesses and with different types in accordance with relationships (the strength of relationships) between the event components.

When the creator of the relation diagram activates the information processing program 120, a relation diagram 30 and a flag tool 300 are displayed on the display 16.

The flag tool 300 includes a flag number (No.) 301 for identifying a flag type, a display input field 302, a frame display input field 303, a color field 304, a name field 305, a flag type field 306, and a details field 307.

The flag No. 301 is for identifying each flag by allocating a number to each flag type. The display input field 302 is where a checkmark is input when a component having a flag set thereto is to be displayed in color. The frame display input field 303 is where a checkmark is input when a component having a flag set thereto is to be displayed by being surrounded by a frame. The color field 304 indicates the type of color to be used when each component having a flag set thereto is to be displayed distinguishably in color. The name field 305 is where a name of a flag is input.

The flag type field 306 indicates a flag type indicating a condition for extracting a component to which a flag is to be set. Examples of the flag type include a component attribute designation option in which a component to which a flag is to be set is selected in accordance with the attributes of the component, such as the created date of the component, the updated date of the component, and the creator of the component, and a free selection option in which a component to which a flag is to be set is selected freely by the creator from the relation diagram.

The details field 307 is where specific conditions related to a component to which a flag is to be set are input. The flag tool 300 also includes, in the lower section thereof, an update button 310, a close button 311 used for saving the set flags and closing the flag tool 300, and an end button 312 used for ending the flag tool 300.

For example, with regard to a flag No. 1, when a checkmark is input to the display input field 302, narrow oblique lines extending from the upper right side toward the lower left side are set in the color field 304, “flag 1” is set in the name field 305, “updated date” is set as a component attribute in the flag type field 306, and “01/24/2019-01/25/2019” is set in the details field 307, a flag is set to each component updated between Jan. 24, 2019 and Jan. 25, 2019.

For example, in the relation diagram 30 in FIG. 3, narrow oblique lines extending from the upper right side toward the lower left side and indicated in the color field 304 are displayed in frames indicating new events (29) to (31) as components updated between Jan. 24, 2019 and Jan. 25, 2019.

Furthermore, for example, with regard to a flag No. 2, when a checkmark is input to the display input field 302, dots are set in the color field 304, “flag 2” is set in the name field 305, “created date” is set as a component attribute in the flag type field 306, and “01/24/2019-01/25/2019” is set in the details field 307, a flag is set to each component (newly) created between Jan. 24, 2019 and Jan. 25, 2019.

For example, in the relation diagram 30 in FIG. 3, dots indicated in the color field 304 are displayed in frames indicating new events (25) to (27) as components (newly) created between Jan. 24, 2019 and Jan. 25, 2019.

Furthermore, with regard to a flag No. 3 and a flag No. 4, the “free selection” option is set in the flag type field 306. This indicates that a component to which a flat is to be set may be freely selected by the creator from the relation diagram 30.

In the above example, the component attributes “updated date” and “created date” are set as flag types for flag 1 and flag 2, respectively. These attributes are registered in the component attribute table 122. The component attribute table 122 includes an event-component attribute table and a connection-component attribute table.

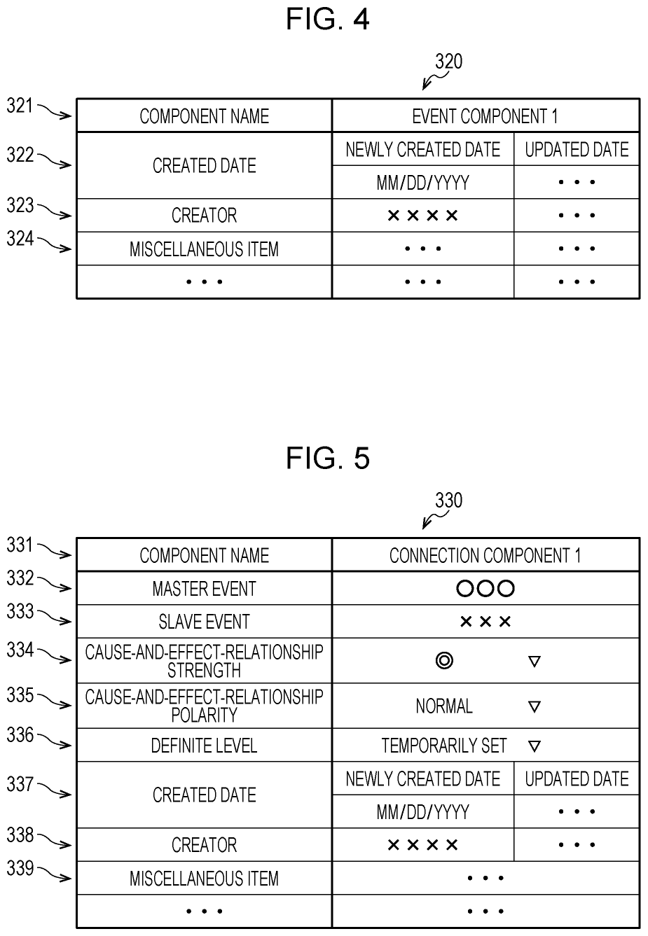

FIG. 4 illustrates an example of an event-component attribute table. An event-component attribute table 320 shown in FIG. 4 includes, for each component name 321, a created date 322, a creator 323, and a miscellaneous item 324, and has these items for the number of event components.

The created date 322 includes a newly created date corresponding to when a component is first created, and an updated date corresponding to when the contents are subsequently updated. In the creator 323, creator information is input in correspondence with each created date. In the miscellaneous item 324, miscellaneous information related to the component is input.

FIG. 5 illustrates an example of a connection-component attribute table. A connection-component attribute table 330 shown in FIG. 5 includes, for each component name 331, a master event 332 and a slave event 333 connected by a connection component, a cause-and-effect-relationship strength 334 indicating the relationship between the master event 332 and the slave event 333, a cause-and-effect-relationship polarity 335, a definite level 336, a created date 337, a creator 338, and a miscellaneous item 339, and has these items for the number of connection components.

For example, the cause-and-effect-relationship strength 334 is displayed in three levels, namely, an extremely strong level denoted by a double circle, a strong level denoted by a single circle, and a weak level denoted by a triangle. When an attribute is to be set, the table as shown in FIG. 5 may be displayed on the display 16, and when each item is to be input, the cause-and-effect-relationship strength may be selected from these three options by using a downward-oriented triangular symbol.

The cause-and-effect-relationship polarity 335 has three options, namely, “normal”, “reverse”, and “none”. The “normal” option is a case where the orientation of the arrows is the same between a master event and a slave event, that is, a case where values thereof increase or decrease in the same direction. The “reverse” option is a case where the orientation of the arrows is the opposite between a master event and a slave event, that is, a case where values thereof increase or decrease in the opposite directions from each other.

The definite level 336 has three options, namely, “temporarily set”, “confirmed”, and “rejected”. The created date 337 has only one field, that is, an updated date, for a newly created date corresponding to the first date of creation in FIG. 5, but may be provided with more fields to show all update histories. In that case, a creator field may be provided for each update history.

A process for setting a flag to each component may involve preliminarily giving predetermined attributes to event components or connection components and registering the attributes in the component attribute table 122, and setting a flag to an event component or connection component corresponding to a designated attribute, or may involve allowing a creator to freely select a component from the relation diagram and setting a flag thereto.

When a flag is set to a component by using the flag tool 300 in this manner, the flag setting unit 100 records the contents set in the flag tool 300 onto the flag setting table 121 in the storage unit 12.

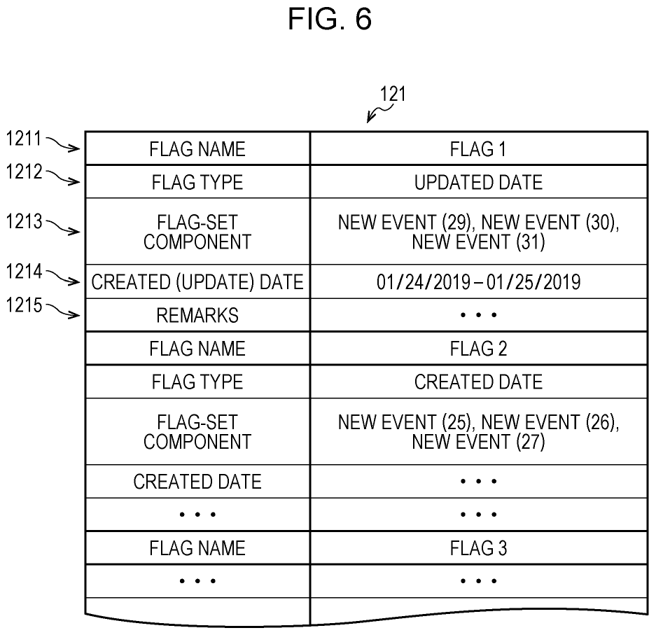

FIG. 6 illustrates an example of the flag setting table 121. For example, the flag setting table 121 has input fields for a flag name 1211, a flag type 1212, a flag-set component 1213, a created (updated) date 1214, and a remarks item 1215.

According to the flag tool 300 shown in FIG. 3, the flag setting contents of “flag 1” as the flag name 1211 are recorded onto the flag setting table 121 such that the flag type 1212 is “updated date”, the flag-set component 1213 includes “new event (29), new event (30), new event (31)”, the created (updated) date 1214 is “01/24/2019-01/25/2019”, and so on. This is similar for other flags.

In accordance with the flags set in this manner, the components with the flags set thereto are distinguishably displayed on the display 16, and the flag setting contents are recorded onto the flag setting table 121. By distinguishably displaying the components with the flags set thereto in this manner, noteworthy points of discussion and updated sections may be readily distinguishable when a relation diagram is to be created or corrected.

In the above example, flags are set to event components indicating events of factors as components constituting the relation diagram. Alternatively, since the components constituting the relation diagram also have connection components (i.e. lines connecting the event components) indicating the relationships between the event components, flags may be set to such connection components. Furthermore, flags may be set to both of these types of components.

In the example shown in FIG. 3, when the components with the flags set thereto are to be distinguishably displayed, oblique lines and dots are displayed in the frames indicating the components. Alternatively, in actuality, the components with the flags set thereto may be displayed using another highlighting method for allowing the components with the flags set thereto to be recognizable by being distinguished from other components, such as displaying the components with the flags set thereto in a highlighted fashion by displaying them distinguishably in color or by increasing the thickness of the frames indicating the components.

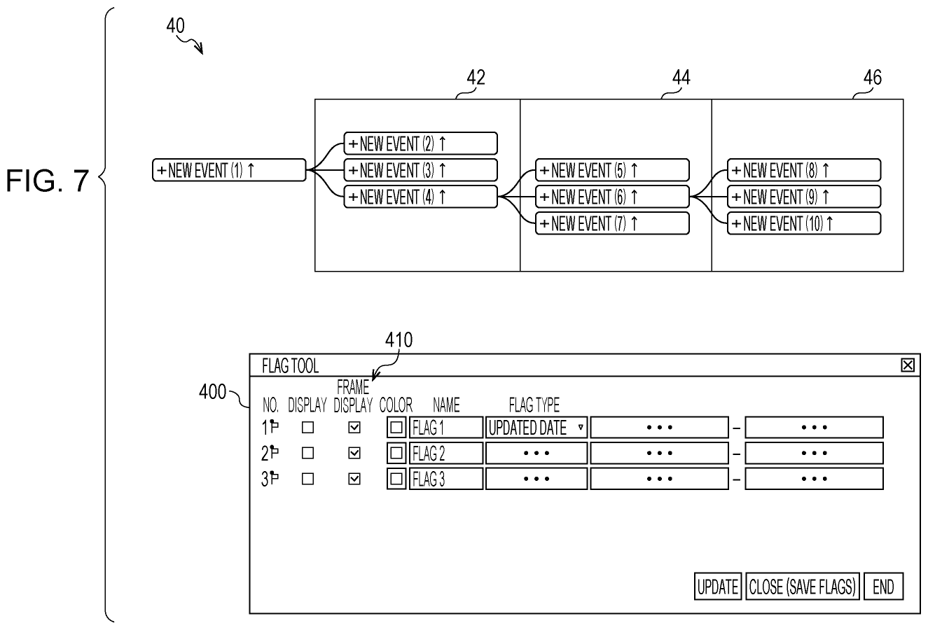

Next, the following description relates to a display method that involves displaying components having the same type of flags set thereto by surrounding them with a frame. FIG. 7 illustrates how components having flags set thereto are displayed by being surrounded by a frame.

As shown in FIG. 7, a flag tool 400 is displayed together with a relation diagram 40 on the display 16. In the flag tool 400, a checkmark is input to a frame display input field 410 for each of “flag 1”, “flag 2”, and “flag 3”.

Assuming that components corresponding to “flag 1” are new events (2) to (4), these new events (2) to (4) are displayed by being surrounded by a frame 42 in the relation diagram 40. Furthermore, assuming that components corresponding to “flag 2” are new events (5) to (7), these new events (5) to (7) are displayed by being surrounded by a frame 44 in the relation diagram 40. Moreover, assuming that components corresponding to “flag 3” are new events (8) to (10), these new events (8) to (10) are displayed by being surrounded by a frame 46 in the relation diagram 40.

In the example shown in FIG. 7, the components having the same type of flags set thereto are displayed by being surrounded by the frames 42 to 46 that are rectangular. Alternatively, the shape of the frames is not limited to a rectangular shape, such that the components having the same type of flags set thereto may be displayed by being surrounded by frames having a freely chosen shape.

Another alternative display method may involve using both the highlighted display method described above and the frame display method. Furthermore, another alternative display method may involve saving multiple patterns used for displaying the components having the flags set thereto and performing display by switching between these patterns.

Although various exemplary embodiments of the present disclosure have been described above, the present disclosure is not limited to these exemplary embodiments. The present disclosure allows various modifications so long as they do not depart from the scope of the disclosure. For example, the information processing program 120 according to the above exemplary embodiment may be provided by being stored in a storage medium, such as a compact disc read-only memory (CD-ROM).

Furthermore, the programs used in the above exemplary embodiment may be stored in an external server, such as a cloud server, and may be used via a network.

Moreover, each of the units constituting the controller 10 may be partially or entirely be constituted of a hardware circuit, such as a field-programmable gate array (FPGA) or an application specific integrated circuit (ASIC).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a setting unit that, on a relation diagram expressing a structure between events, sets additional information to each of components constituting the relation diagram; and
a display unit that distinguishably displays each of the components having the additional information set thereto in accordance with the additional information.

2. The information processing apparatus according to claim 1,
wherein the components constituting the relation diagram include event components indicating the events and connection components indicating relationships between the event components.

3. The information processing apparatus according to claim 2,
wherein the setting unit sets the additional information to any of the event components or connection components designated on the relation diagram, and
wherein the display unit displays the event component or connection component having the additional information set thereto distinguishably from others.

4. The information processing apparatus according to claim 3,
wherein the setting unit preliminarily gives predetermined attributes to the event components or connection components and sets the additional information to the event component or connection component corresponding to a designated attribute.

5. The information processing apparatus according to claim 4,
wherein the attribute is an updated date or a newly created date.

6. The information processing apparatus according to claim 4,
wherein the attribute is information indicating a creator of the relation diagram.

7. The information processing apparatus according to claim 4,
wherein the display unit is capable of saving a plurality of display patterns and performs display by switching between the plurality of display patterns.

8. The information processing apparatus according to claim 5,
wherein the display unit is capable of saving a plurality of display patterns and performs display by switching between the plurality of display patterns.

9. The information processing apparatus according to claim 6,
wherein the display unit is capable of saving a plurality of display patterns and performs display by switching between the plurality of display patterns.

10. A non-transitory computer readable medium storing a program causing a computer to execute a process, the process comprising:
on a relation diagram expressing a structure between events, setting additional information to each of components constituting the relation diagram; and
distinguishably displaying each of the components having the additional information set thereto in accordance with the additional information.

11. An information processing apparatus comprising:
setting means for setting, on the relation diagram expressing a structure between events, additional information to each of components constituting the relation diagram; and
display means for distinguishably displaying each of the components having the additional information set thereto in accordance with the additional information.
